(19) United States
(12) Patent Application Publication
(10) Pub. No.: US 2010/0186782 A1
(43) Pub. Date: Jul. 29, 2010

(54) PRESSURE WASHING SYSTEM FOR VEHICLES

(76) Inventor: Rafael Tomás Boix, Valencia (ES)

Correspondence Address: WENDEROTH, LIND & PONACK, L.L.P., 1030 15th Street, N.W.,, Suite 400 East, Washington, DC, 20005-1503, US

(21) Appl. No.: 12/666,863

(22) PCT Filed: Mar. 17, 2008
(86) PCT No.: PCT/ES2008/000148

§ 371 Date: Apr. 7, 2010

(30) Foreign Application Priority Data
Jun. 28, 2007 (ES) P200701807

(51) Int. Cl. B08B 3/04

(52) U.S. Cl. 134/123

(57) ABSTRACT

The invention relates to a pressure washing system for vehicles wherein, prior to being pressure washed with water, the vehicle is first prewashed with water and sprayed with a chemical cleaning product, said steps being performed by parts built into a moving washing arch (1). A final drying step is performed by a traditional system which may be built into the arch or take the form of a remote stationary element. While the vehicle is being sprayed with the chemical cleaning product, the different heights of the vehicle are saved so that cycle duration times and water consumption can be optimised when the vehicle is being pressure-washed with special nozzles (2B). The cone-jet nozzles (2B) are disposed on a vertical supporting element (3) which can oscillate by means of a mechanism (5) having controlled movements, combined with the forward speed of the washing arch (1), in accordance with orders received from a central processing unit (CPU) as a function of the dimensions of the vehicle.

### OBJECT OF THE INVENTION

The present invention, as expressed in the caption of this specification, relates to a pressure washing system for vehicles that envisages enhanced characteristics and technical advantages over current washing systems, offering an aspect of total innovation that optimises pressure washing systems with water to a maximum, both in terms of cycle times and water consumption, due to the fact that the automatic actuation system does so in accordance with the volume defined by the vehicle itself, i.e. taking into account the exact geometry of the vehicle, the surface of which is successively subjected to the washing nozzles.

### BACKGROUND OF THE INVENTION

Although some pressure washing systems with water are known, which can be differentiated between manual and automatic, most of the automatic embodiments use pressurised water combined with a traditional roller washing system.

The technical solution that the invention aims to provide is the implementation of a pressure washing process without the need for complementing said wash with built-in synthetic fibre rollers.

### DESCRIPTION OF THE INVENTION

Generally speaking, the pressure washing system for vehicles that is the object of the present invention falls within the automotive auxiliary industrial sector, the process of which is based on the following basic steps or sequential phases:

Positioning of the vehicle in the positioner and activation of the washing programme.

Spraying of a chemical product over the surface of the vehicle and memorisation of the different heights thereof.

Prewashing with water and shampoo.

Rinsing of the chemical product by applying pressurised water through nozzles that, due to their architecture, dose the water in conical projections.

Drying of the vehicle by means of traditional drying, built into the arch or taking the form of a remote stationary element.

The main element of novelty provided by the invention is the implementation of a supporting element for the nozzles which can oscillate vertically by means of a pneumatic, electrical or mixed device associated to said supporting element.

This vertical oscillation of the supporting elements of the nozzles disposed on either side of the moving arch allows it, in conjunction with its forward-moving capacity, to produce a characteristic global and new effect that leaves the vehicle completely clean.

With this oscillating effect of the supporting element of the ejection nozzle, with pressurised water, depending on the vehicle reading made during the chemical spraying step, the machine can modify the aforementioned variables as required based on the dimensions of the surface to be washed. With this we avoid the zig-zag effect that could be caused by the oscillation of the nozzles with a continuous forward movement of the arch. This problem is completely solved on enabling regulation of the forward movement of the arch.

The different washing nozzles are mounted on a supporting element, the vertical movement of which is guided along the respective rod, which is solidarily attached to the corresponding side of the washing arch. The nozzles emerge through a vertical groove in the casing thereof.

In order to better understand the characteristics of the invention and forming an integral part of this specification, it is accompanied by sheets of drawings, the figures of which represent the following in an illustrative and non-limiting manner:

### BRIEF DESCRIPTION OF THE DRAWINGS

FIG. 1 shows a perspective view of a moving vehicle washing arch which includes the washing system that is the object of the invention, where the nozzles that eject the chemical product and pressurised water can be observed.

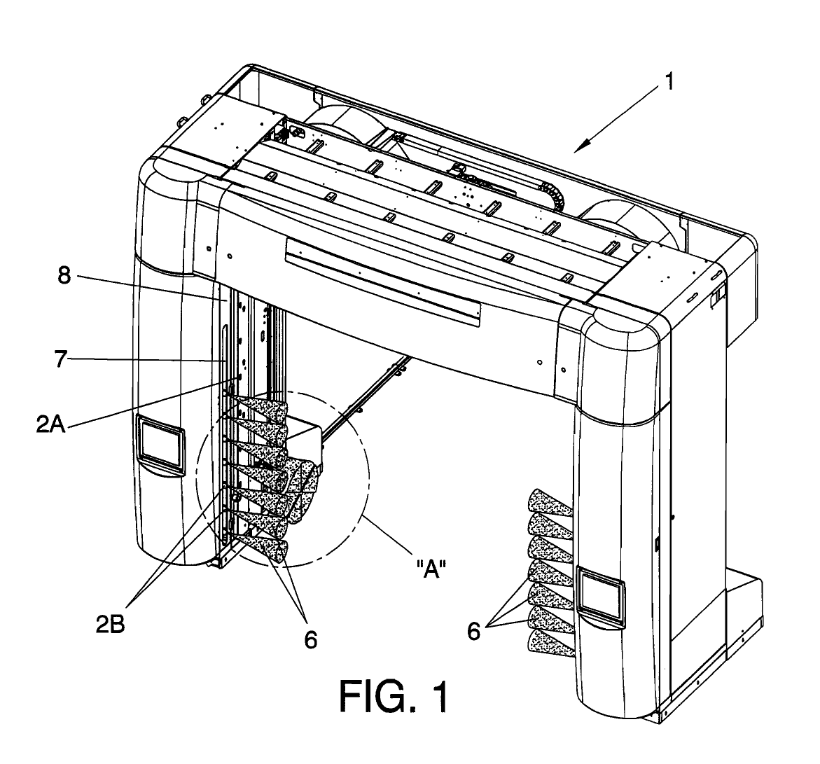

FIG. 2 shows a partial perspective view of same moving washing arch of FIG. 1, specifically of the main body whereon the oscillating supporting elements with the nozzles and their actuation cylinders are disposed.

FIG. 3 shows an expanded view of detail A of FIG. 1.

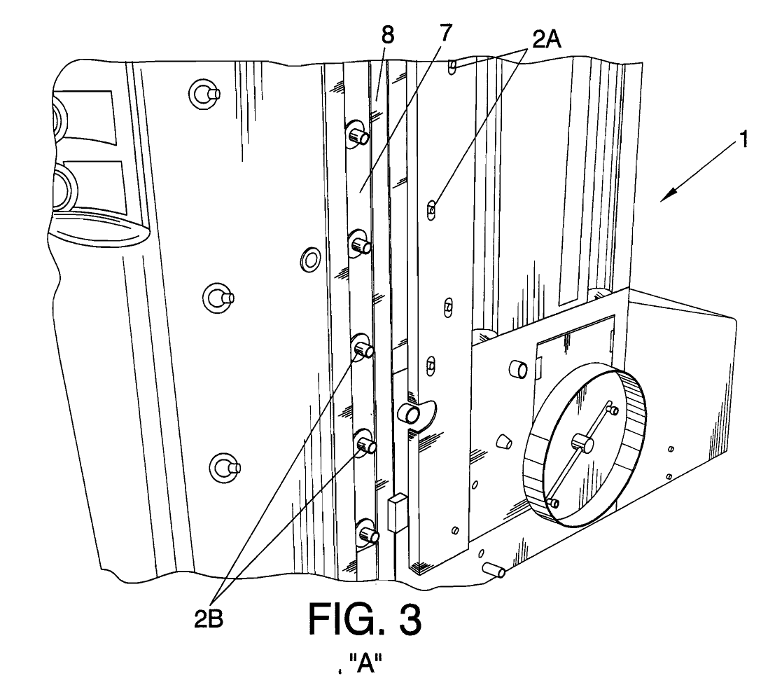

FIG. 4 shows a block diagram of the pressure washing system that is the object of the invention.

### DESCRIPTION OF THE PREFERRED FORM OF EMBODIMENT

In reference to the numbering system used in the figures, we can see how the pressure washing system for vehicles proposed by the invention is implemented in a washing arch 1 wherein nozzles 2A are vertically aligned on each of the branches or sides of the arch 1, through which it produces the initial spraying with a chemical cleaning product and final pressurised rinsing or pressure washing by the nozzles 2B.

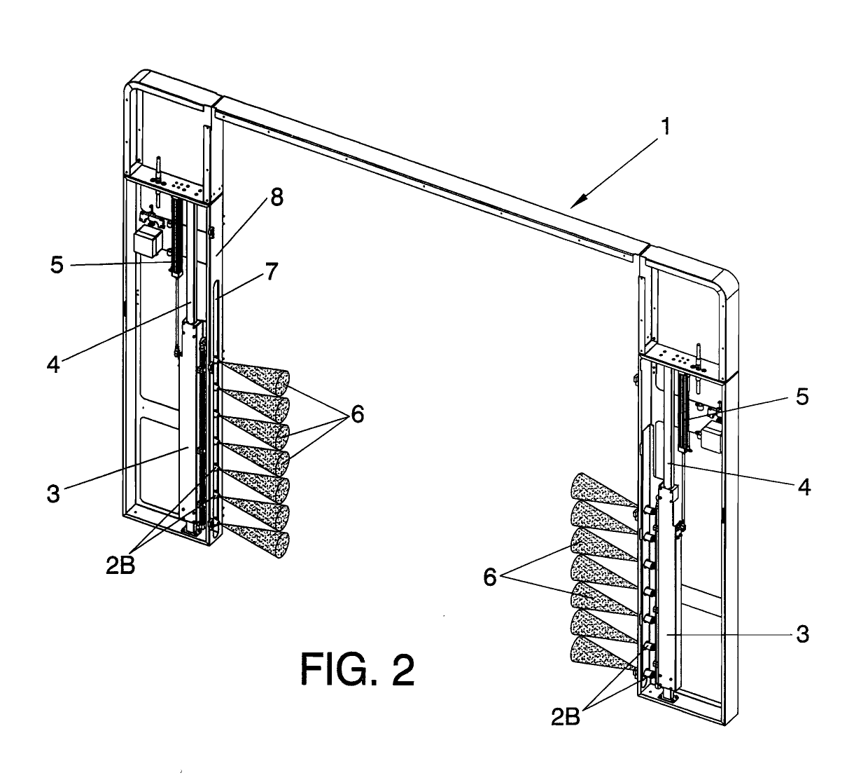

The nozzles 2B on either side are disposed on the respective supporting element 3 that is vertically movable along the guides 4, as can be clearly observed in FIG. 2. The oscillating movements of the supporting element 3 are achieved in this case by means of the mechanical, hydraulic, pneumatic or mixed cylinder 5, but this movement could have equally been achieved by means of a swinging movement with a spindle nut device or similar, actuated by the corresponding electric motor.

These vertical oscillating movements of the supporting element 3 are controlled by the central processing unit (CPU) and depend on the dimensional geometry of the vehicle positioned before the arch 1, upon activating the washing programme.

The conical effect of the pressure washing nozzles 2B is represented in the figures and referenced as number 6, emerging from the vertical groove 7 envisaged for such purpose in the casing 8 of the washing arch 1.

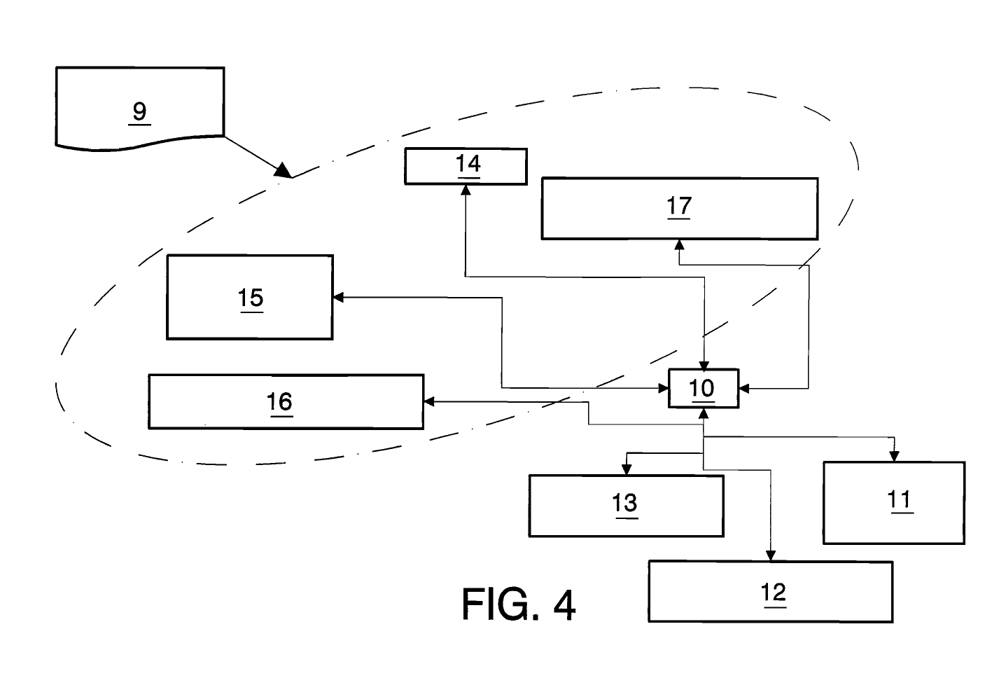

Making special reference to FIG. 4, which shows the block diagram of the pressure washing system for vehicles at hand, we can observe the existence of functions inherent to a traditional washing system and other outstanding functions contained within an ellipse, with the new functions or blocks 9 that enable the characteristic cleaning effect of the invention.

The CPU is referenced as number 10 and controls system operation once the detector 11 indicates the presence of a vehicle. Reference 12 designates the selection interface of the washing programme, subsequent to which the drying system actuator 13 intervenes, materialised in a traditional drying arch as mentioned earlier.

Blocks 10 to 13 are traditional, as they are common to current washing systems. The new blocks 9 graphically contained within the ellipse of this FIG. 4 to which we are referring are: the memory 14, the vehicle height dimension detector 15, in conjunction with the forward movement of the washing arch 1; the actuator 16 of the vertical movement cylinder 5 for the nozzles 2B and the forward speed regulator 17 of the washing arch 1. This last function acts in accordance with the part of the vehicle that is being washed at a given time, measured during the previous step of the washing process or spraying with the chemical product, as such forward speed shall depend on the height of the vehicle at a given time as it passes by the nozzles.

1. PRESSURE WASHING SYSTEM FOR VEHICLES, which includes spraying with a chemical cleaning product and prewashing with water and shampoo prior to washing with pressurised water by means of a washing arch, and traditional final drying, built into the arch or taking the form of a remote stationary element, which includes a device that sprays a chemical cleaning product (2A) on the vehicle surface and cone-jet dosing nozzles (2B) disposed on a supporting element (3) on either side of the washing arch (1), capable of vertical oscillation on being assisted by a mechanical, pneumatic, electric or mixed cylinder (5) that acts in conjunction with the forward movement of the supporting elements (3) of the nozzles (2B) and the forward movement of the washing arch (1), in accordance with orders received from a control unit (CPU) based on the dimensional values of the vehicle, which are previously obtained during the spraying process with the chemical product, whereby the speed of the forward movement is adjusted in accordance with the vertical oscillation movement of the nozzles (2B), in order to avoid the zig-zag movement.

2. PRESSURE WASHING SYSTEM FOR VEHICLES, according to claim 1, characterised in that the vertical movement length of the nozzles 2 is proportional to the height of the vehicle at a given time during the forward or backward movement of the arch.

3. PRESSURE WASHING SYSTEM FOR VEHICLES, according to claim 1, characterised in that the supporting element (3) slides over vertical guides (4) solidarily attached to the sides of the washing arch (1) and is connected to a cylinder (5), wherein the dosing nozzles (2B) emerge outwards through a vertical groove (7) on the casing (8) of the washing arch (1).
